(19) United States
(12) Patent Application Publication
(10) Pub. No.: US 2003/0013511 A1
(43) Pub. Date: Jan. 16, 2003

(54) Gaming apparatus and gaming apparatus control method

(75) Inventor: Takahiro Suzuki, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: ARUZE CORPORATION, Tokyo (JP)

(21) Appl. No.: 10/195,511

(22) Filed: Jul. 16, 2002

(30) Foreign Application Priority Data
Jul. 16, 2001 (JP) 2001-215743

(51) Int. Cl. A63F 13/00

(52) U.S. Cl. 463/16

(57) ABSTRACT

[An apparatus] comprising display having 3 rows by 5 columns of display regions and controller. Controller determines whether to run a bonus game after the reels have stopped spinning and, in the event that a bonus game is to be run after the reels have stopped, announces the fact prior to spinning the reels. Announcement of the bonus game is made by displaying a character in the display regions of display, and, in the event that an announcement has been made, [the apparatus] switches to the bonus game after the reels have stopped spinning.

### BACKGROUND OF THE INVENTION

1. Field of the Invention

The present invention relates to a gaming apparatus which displays symbols in a plurality of display regions and determines prizes to be awarded to the player based on the arrangement of the symbols, a method of controlling the gaming apparatus, a program, and a computer-readable recording medium.

2. Description of the Related Art

Slot machines can be cited as typical examples of gaming apparatuses in which the symbols to be displayed in each of a plurality of display regions are determined by random values and prizes or monetary prizes are paid out based on the arrangement of the symbols on the display.

Recently, slot machines with bonus games provided as a means of attracting player interest have become popular. These bonus games are ones which run, for example, when symbols occur in a specified arrangement on the slot machine, and they may proceed on the display which displays the slot game or may unfold on a second display, different from that display. A prize or monetary prize is paid out to the player according to the results of the bonus game.

### SUMMARY OF THE INVENTION

In general, Bonus games in the above-mentioned conventional gaming apparatuses are started when symbols in the slot game occur in a prescribed arrangement, for example in the case that “bonus symbols” line up, and the player is notified of the start of a bonus game. In other words, the situation is that, until the bonus symbols line up, the player does not know if a bonus game will be run or not. As a result, it was hard for a player to confirm that a bonus game had started. Moreover, players are dissatisfied with gaming apparatuses equipped with this kind of conventional bonus game; they want even newer gaming apparatuses to appear.

An object of the present invention is to provide a gaming apparatus, a method of controlling the gaming apparatus, a program, and a computer-readable recording medium which, through a new method of running bonus games, can make it easy for the player to recognize that a bonus game has begun and can attract player interest.

The present invention comprises a display, which has a plurality of symbol display regions in which a plurality of symbols are variably displayed, and a controller which executes a prescribed program and controls a display content of the display. The invention is characterized in that, responsive to the program, the controller determines whether or not to run a bonus game after the variation of the symbols stops. In the case that a decision is made to run a bonus game, a bonus game announcement is made before start of symbol variation, and display of varying symbols is caused to be performed on the display. The invention is also characterized in that, from among a plurality of symbols, the symbols to be made to stop in each display region are determined and a prize to be awarded to the player based on an arrangement of the symbols displayed in each display region is decided. Then, in the case that notification of the bonus game has been awarded, the bonus game is run after the symbols stop.

With the gaming apparatus of the present invention, because the bonus game is announced prior to start of symbol variation, the player can know ahead of time that a bonus game will be run after the symbols stop. As a result, the player can be mentally prepared for a bonus game and can readily confirm the start of a bonus game.

It is acceptable if the controller announces a bonus game only when the player has credits.

It is also acceptable for the controller to announce a bonus game whether or not there are credits. In this way, by announcing a bonus game even at times when there are no credits, a person who happens to see the game can be drawn to it and can be made to play the game.

It is acceptable if the controller can run a bonus game only when the symbols appear in a special arrangement. In this way, a strong sense of anticipation can be created in the player, hoping that the symbols will appear in the special arrangement, and the amusement level can be heightened.

It is acceptable if the controller determines whether or not to run a bonus game for the next game after detecting that symbol variation in the previous game has stopped. In this way, by only informing the player whether or not a bonus game will be run for the next game after the symbol variation of the previous game has stopped, the player can be made to have a continuing sense of anticipation in each game that a bonus game can be played, and thus the player can be made to continue the game even more.

The present invention is a slot machine equipped with a display having a plurality of symbol display regions in each of which a plurality of symbols are variably displayed. The invention is characterized in that a varying display is caused on the display and, from among a plurality of symbols, the symbols to be stopped in each display region are determined and a prize to be awarded to the player is decided based on an arrangement of symbols displayed in each display region. The invention also comprises a control means for determining whether or not a bonus game will be run after stopping the variation of the symbols and a control means for running the bonus game after the symbols stop, in the case that notification of the bonus game has been awarded.

With the slot game of the present invention, because the bonus game is announced prior to start of symbol variation, the player can know ahead of time that a bonus game will be run after the symbols stop. As a result, the player can be mentally prepared for a bonus game and can readily confirm the start of a bonus game.

The gaming apparatus control method of the present invention is a control method for a gaming apparatus which apparatus comprises a display, having a plurality of symbol display regions in which a plurality of symbols are variably displayed, and a controller which controls the display. The control method comprises the steps of: determining whether or not a bonus game will be run after varying of the symbols has stopped; in the case that a decision has been made to run a bonus game, announcing the bonus game before the start of symbol varying; causing a varying display of symbols on the display; from among a plurality of symbols, determining the symbols to be made to stop in each display region; determining the prize to be awarded to the player based on the arrangement of symbols displayed in each display region; and, running a bonus game after the symbols stop, in the case that notification of a bonus game has been given.

With the gaming apparatus control method of the present invention, because the bonus game is announced prior to start of symbol variation, the player can know ahead of time that a bonus game will be run after stopping the symbols. As a result, the player can readily confirm the start of a bonus game. In addition, by making it such that there is a possibility of a bonus game being run regardless of the symbol arrangement, even if the player cannot win a prize because of the arrangement of the symbols, there is a chance to win a prize through the bonus game. Moreover, because there is a chance of wining prizes based on symbol arrangement and also through the bonus game, a player's sense of expectancy is heightened and fresh interest is generated.

In the gaming apparatus control method of the present invention, it is acceptable if the controller announces a bonus game only when the player has credits. In this way, it can be made clear to the player that his credits are depleted and the game has ended.

In the gaming apparatus control method of the present invention, it is also acceptable if the controller runs a bonus game only when the symbols go into a special arrangement. In this way, the player can be made to hope that the symbols will go into the special arrangement and thus the amusement level can be heightened.

It is acceptable if the gaming apparatus control method of the present invention determines whether or not to run a bonus game for the next game after detecting that symbol variation in the previous game has stopped. In this way, by only informing the player whether or not a bonus game will be run for the next game after the symbol variation of the previous game has stopped, the player can be made to have a continuing sense of anticipation in each game that a bonus game can be played. Thus the player can be made to continue the game even more.

The program of the present invention comprises the steps of: determining whether or not a bonus game will be run after varying of the symbols has stopped; in the case that a decision has been made to run a bonus game, announcing the bonus game before the start of symbol varying; causing a varying display of symbols on the display; from among a plurality of symbols, determining the symbols to be made to stop in each display region; determining a prize to be awarded to the player based on an arrangement of symbols displayed in each display region; and, in the case that notification of a bonus game has been given, running a bonus game after the symbols stop.

The computer-readable recording medium according to the present invention is characterized in that the above-mentioned program is stored in it.

By running this kind of program on a computer, the kind of effect discussed in the description of the above-mentioned gaming apparatus and gaming apparatus control method can be obtained. That is, in the case that it has been decided to run a bonus game, by announcing that before variation of symbols begins, the player can readily confirm the start of a bonus game and the player can be attracted to the game.

The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

The present invention may be more readily described with reference to the accompanying drawings in which:

FIG. 1 is a perspective view showing the external appearance of a gaming apparatus (slot machine) according to the present invention;

FIG. 2 is a block diagram showing the controller that controls the processing of the slot machine of FIG. 1;

FIG. 3 is an illustration showing the display screen of the main display;

FIG. 4A and FIG. 4B are diagrams showing the “pay line” of slot machine 10;

FIG. 5 is a symbol table showing the symbols displayed on each reel;

FIG. 6 is a flow chart showing the slot machine control method up to the start of a bonus game;

FIG. 7 is an illustration of a display screen of the situation where a bonus game is announced;

FIG. 8 is a configuration diagram showing each module in the program of the present invention; and

FIG. 9 is a diagram showing a computer-readable recording medium (CD-ROM) in which the program of FIG. 8 is recorded.

### DESCRIPTION OF THE PREFERRED EMBODIMENTS

Below, the preferred embodiments of the invention are described in detail, referring to the accompanying drawings. Note that the same key numbers are used for identical elements and repetitive descriptions are omitted.

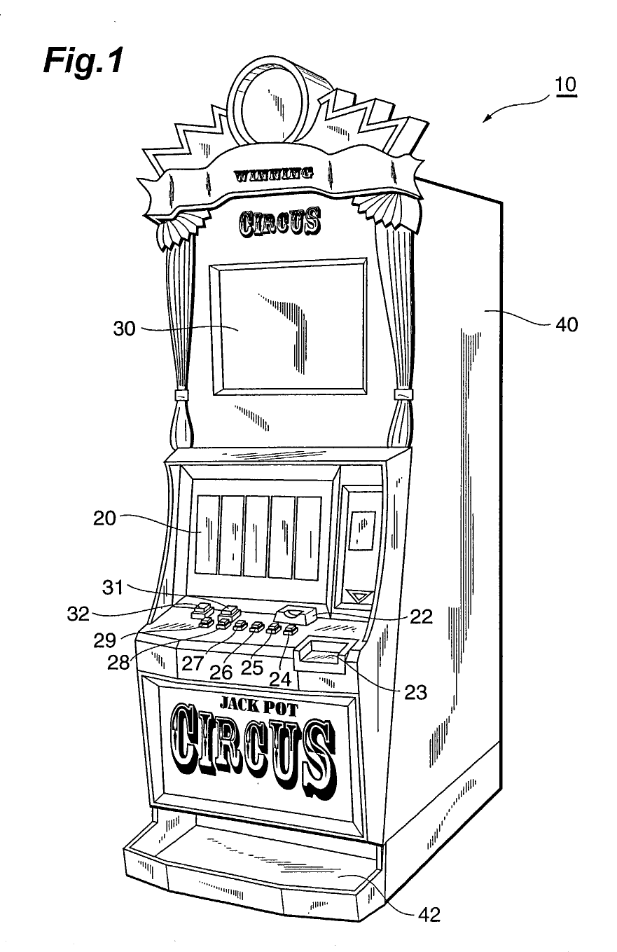

FIG. 1 is a perspective view showing the external appearance of slot machine (gaming apparatus) 10 according to the present embodiment. In slot machine 10, the lower part of cabinet 40 is equipped with main display 20 for digital display of the slot game and the upper part of cabinet 40 is equipped with second display 30 for digital display of the bonus game which will be described later. Both main display 20 and second display 30 are liquid crystal displays, and the main display is a touch screen display. Note that it is also acceptable to digitally display the bonus game on main display 20.

Below and in front of main display 20 are provided a coin slot 22 for inserting a medium such as a token or coin (below, these are referred to by the general term “coin”), and a bill inserter 23 for inserting money bills. The player can play the slot game using either coins or bills. Of course, it is also possible to design the apparatus such that the game is conducted using only coins or bills. In addition, in the lowest part of cabinet 40, a coin receiving part 42 is provided where the player receives the coins that are paid out.

In front of coin slot 22, six push buttons are arranged. These are buttons provided on commonly known slot machines, and in order from the left include: a start button 24 for directing the start of symbol rotation, a BET button 25 for indicating 1 BET, a MAXBET button 26 for placing a BET from the number of remaining credits up to the maximum bet number (for example 30), a REPEATBET button 27 for placing a BET of the same amount as in the previous play, a collect button 28 for confirming the coins which have been won in the games, and a payout button 29 which instructs that the coins be paid out. In addition, to the left of coin slot 22 in the figure, two selection buttons 31 and 32 are provided for use in bonus game which are played on second display 30.

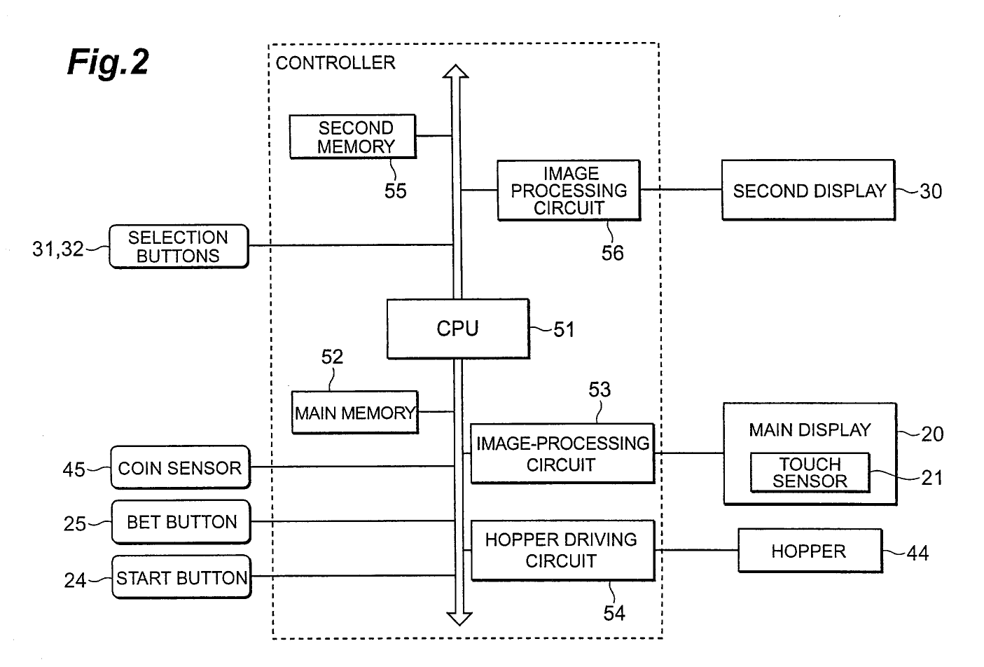

FIG. 2 is a block diagram showing the controller 50 that controls the processing of slot machine 10 of this embodiment and the various actuators which are electrically connected thereto.

Included in controller 50 are: a CPU 51 for integrating the various control functions; main memory 52, serving as a storage means storing the program and data necessary for the slot game; an image processing circuit 53 which has Video RAM and controls the display content of the main display 20; a hopper driving circuit for controlling a hopper 44 which pays out the accumulated coins to the player; second memory 55, serving as a storage means storing the program and data necessary for the sub-games; and an image processing circuit 56 which has Video RAM and controls the display content of the second display 30. In addition, between CPU 51 and the various actuators, I/O ports and so on are appropriately placed.

Main memory 52 has ROM area and RAM area, and in the ROM area thereof are included at least a program, which includes a module for running the slot game and the bonus game (described below) and a module for determining whether or not a bonus game will be run after the symbol changing; data related to symbol images and to a pay table showing the payout according to the symbol arrangement. Likewise, in the RAM area of main memory 52, variable data such as the player's BET number, credit number, etc. are written in. Concerning second memory 55 also, ROM area and RAM area are provided in the same way. In the ROM area thereof, programs and data related to a plurality of bonus games are written in. In addition, touch sensor 21 is incorporated in main display 20 and the player can input various kinds of information by touching the display screen.

Further, connected to CPU 51 via a bus are: a coin sensor 45 for detecting the insertion of a coin, a start button 24, a BET button 25, selection buttons 31 and 32, etc. In addition, although omitted from the drawings, various buttons, a bill sensor, etc. are also connected to the controller 50. Also, the aforementioned hopper 44 and coin sensor are contained in the cabinet 40 shown in FIG. 1.

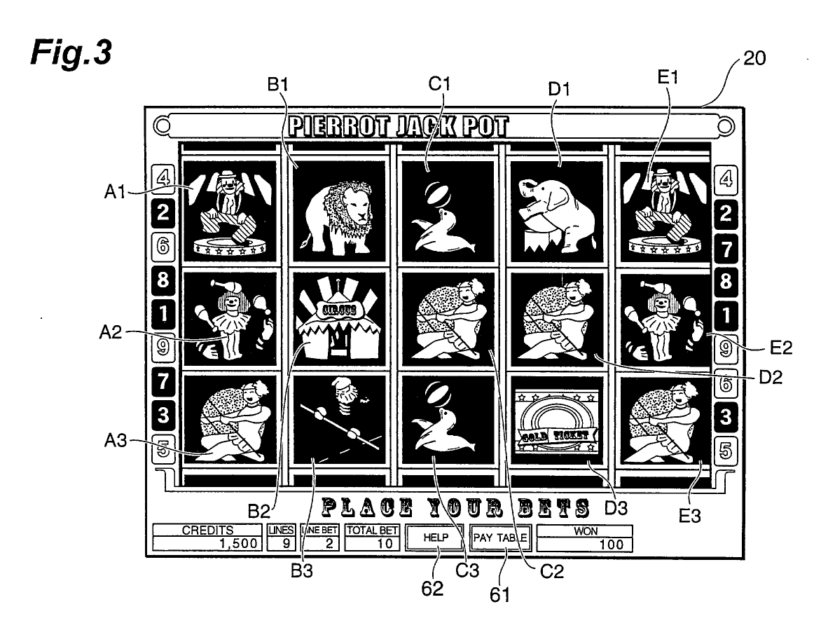

FIG. 3 is an illustration that shows an example of the display screen of main display 20 and specifically the situation where a bonus game is not announced. In the present embodiment, a total of 15 display regions, 3 rows by 5 columns, are provided in the main display 20 for displaying a plurality of symbols. In addition, image processing is done such that reels with a plurality of types of symbols depicted on the circumferences thereof rotate, and when each reel stops, the selected symbols are displayed in display regions A1 through A3, B1 through B3, C1 through C3, D1 through D3, and E1 through E3.

In addition, below the display regions, the following are displayed: number of remaining credits, number of effective lines (LINES), LINE BET, which is the BET number for each line, TOTAL BET, which is the total number which the player has bet this time, the payout amount the player has won in this game (WON), etc. In addition, on main display 20 are displayed: PAY TABLE key 61 for instructing display of the pay table which shows the amounts which are paid to players, and HELP key for requesting advice when the game method, etc. is unclear. When the player touches these keys 61 and 62, that touch is detected by touch sensor 21, and a pay table and an explanation of the operating method are displayed on the screen respectively.

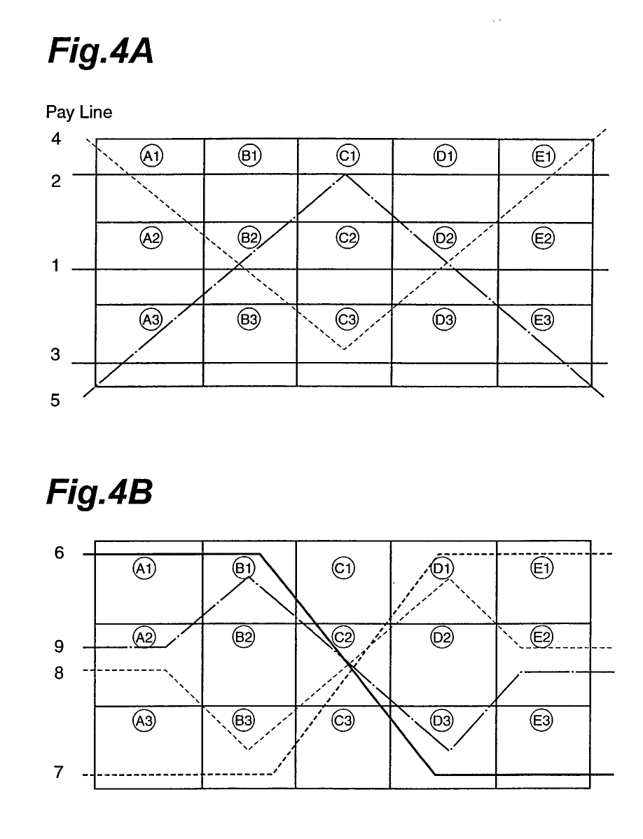

FIG. 4A and FIG. 4B are diagrams showing the pay lines of slot machine 10. To simplify comprehension, pay lines are shown separated into two figures. As shown in each figure, in this game, nine pay lines have been prepared. If the prescribed symbols line up on any of these pay lines, a payout is paid to the player according to the prescribed line up. With the 3 row by 5 column layout of the present embodiment, because the number of columns has been increased in this way, a variety of pay lines can be configured.

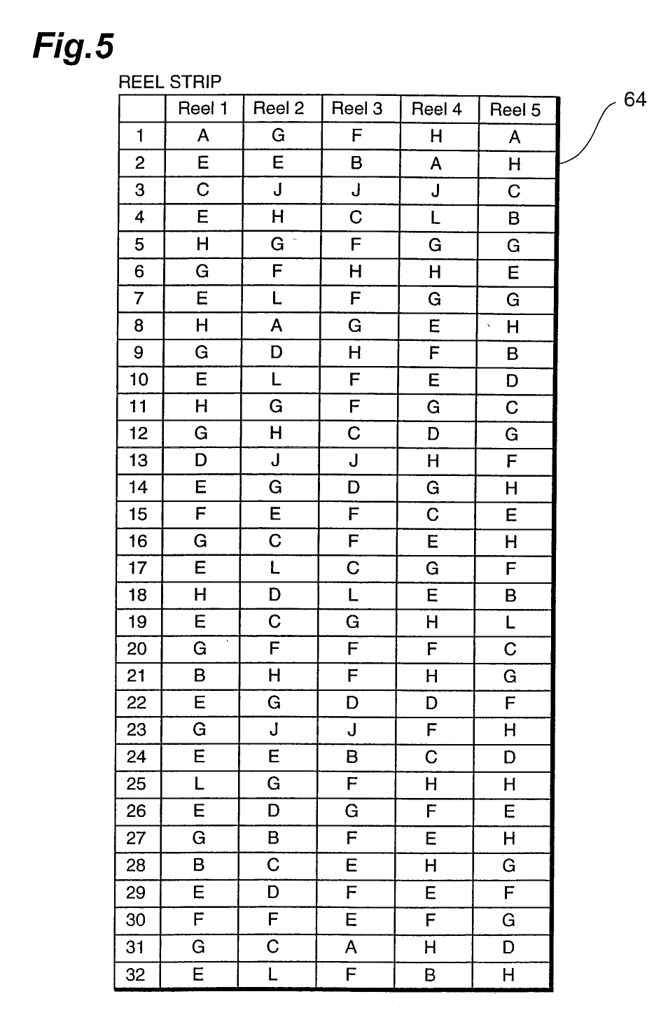

FIG. 5 is symbol table 64 which shows the symbols displayed on each reel. The information of this symbol table 64 is stored in main memory 52. The letters in the table are ones which indicate the type of each symbol. In the display regions of main display 20, images are formed as though symbols were depicted on the reels in the order shown in this symbol table 64.

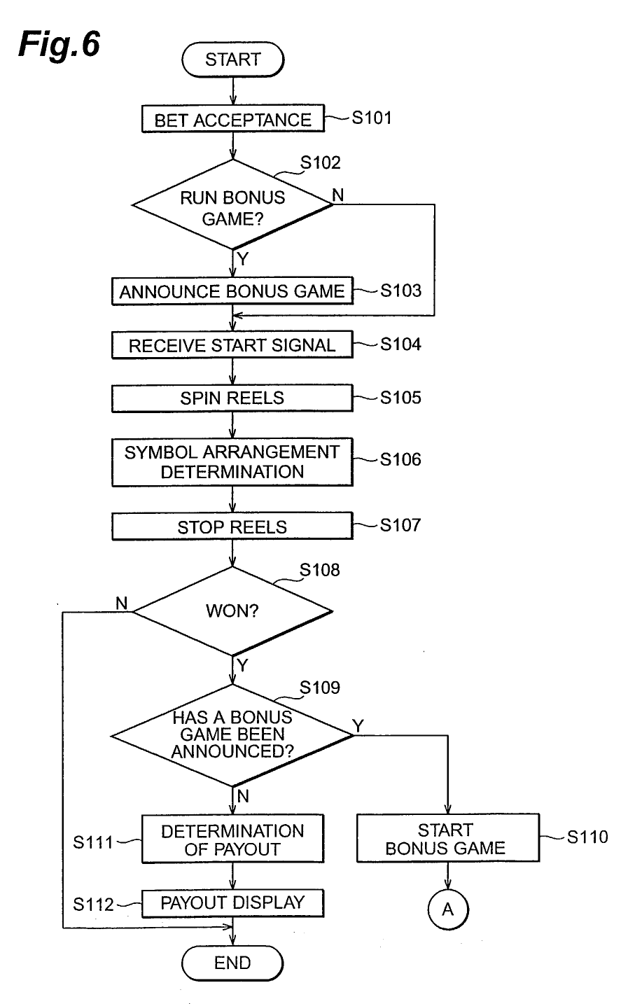

Next, the control method of the slot machine of the present embodiment will be described referring to the flow chart of FIG. 6.

When slot machine 10 is operated, CPU 51 accesses main memory 51 and transfers to image processing circuit 53 the information related to the basic screen of the slot game, such as a framework to form the display region, PAY TABLE key 61, etc. In image processing circuit 53, this information, after once being stored in Video RAM, is displayed on main display 20. In this way, the slot machine goes into the state where a player can play the slot game. The following processing is accomplished by running the module relating to the slot game on CPU 51, the program having been stored in main memory 52.

In step 101 (below, “step” is abbreviated as “S”), CPU 51 of controller 50 awaits the player's BET. A BET can be placed in a situation where credits remain, and the player indicates the BET number using any of the BET button 25, MAXBET button 26, or REPEATBET button 27.

When BET placing is complete, CPU 51, as a decision-making means, determines according to the program of main memory 52, whether or not to run a bonus game (S102). This decision is made by a method such as using random number values.

When it is determined to run a bonus game, CPU 51, as an announcement means, controls image-processing circuit 53 and announces the bonus game to the player by displaying on the display a character who announces the bonus game(S103). The announcement means is configured from CPU 51, main memory 52, and image-processing circuit 53.

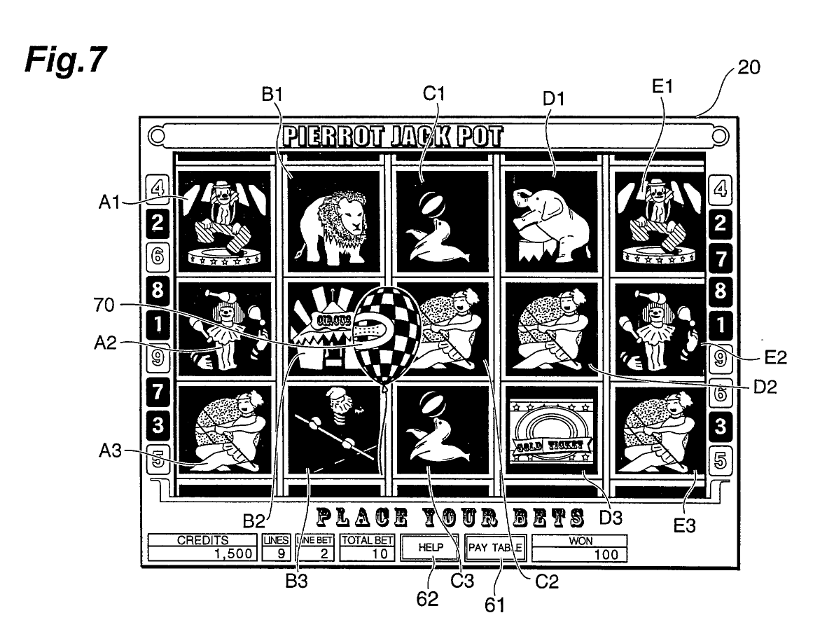

FIG. 7 is an illustration of the situation where a bonus game is announced by the display of balloon character 70 on main display 20. Balloon character 70 is displayed floating up from the lower side of the display.

Note that in the present embodiment, to announce the bonus game, the balloon character is displayed on main display 20, but the character is not limited to this. In addition, announcement of the bonus game may also be done not by means of a figure, but by displaying text or the like. Further, this balloon character 70 may be displayed moving within main display 20 or in a still condition.

Here it has been said that deciding whether or not to run a bonus game and announcing the bonus game are done only when there are credits, but it is acceptable for the decision about announcement and the announcement to be made when there are no credits. In this way, a person in the casino or game center who happens to see the game can be drawn to it and can be made to play the game.

In the case that there are remaining credits, it is also acceptable for the CPU 51 to determine whether or not to run a bonus game after detecting that the reels have stopped spinning in the previous game and to announce that bonus game. In this way, the player can be made to have a continuing sense of anticipation in each game that a bonus game can be played, and thus the player can be made to continue the game even more.

Announcement of a bonus game may be done by sound or may of course be done by display of a character in combination with sound. In addition, the bonus game may be announced to the player, for example, by causing cabinet 40 to shake.

On the other hand, in the case that in S102 it is determined not to run a bonus game, processing proceeds next to S104.

Next, when player presses start button 24 (S104), the reels begin to spin on main display 20 (S105). Specifically, CPU 51, receiving a start signal from start button 24, controls image-processing circuit 53 and performs image processing to make it appear as though actual reels are spinning. Furthermore, in the case that the player presses MAXBET button 26 or REPEATBET button 27, the reels begin to spin without start button 24 being pushed.

After the reels begin to spin, CPU 51 generates random numbers by means of the program in main memory 52 and, based on those values, determines the reel stop positions, that is, the symbols to be displayed in each display region (S106). This selection, based on random number values, can be done with any timing. For example, the selection may be done when the start button 24 is pushed or re-selection may be done each time the BET button is pushed.

Next, CPU 51, controlling image-processing circuit 53, stops the reels displayed on main display 20 (S107). At this time, it may be set up such that one symbol is certainly displayed in each display region, or it may be set up so that there are cases when, based on random number values, symbols are not displayed or only a portion of the symbols are displayed. With the present embodiment, it is assumed that one symbol will certainly be displayed in each display region.

After the reels have spun, CPU 51 determines the winnings (S108). Moreover, because the decision about winnings can be made at the time that the symbol arrangement is determined in S106, S108 may be done before S107. In the case that the symbols are not in a winning arrangement, the slot game ends and, for example, “GAME OVER” is displayed on the main screen.

In S108, in the case that the symbols are in a winning arrangement, CPU 51 decides whether in S103 a bonus game has been announced or not (S109). In the case that a bonus game has been announced, CPU 51 transitions to the bonus game (S110). At this time, a payout may be paid according to the winnings.

To run the bonus game of S110, execution means CPU 51, executes the program module relating to the bonus game, the program having been stored in second memory 55. The execution means is configured of CPU 51, second memory 55 and image-processing circuit 56.

The bonus game performs, for example, the following actions. CPU 51 controls image-processing circuit 53 and image-processing circuit 56 and displays balloon character 70 which, displayed on main display 20, announces the bonus game in a way that makes it appear as though it moves from main display 20 to second display 30. Next, the clown character is made to appear in the scene and is made to shoot through balloon 70 with a bow and arrow, causing the balloon to burst. Simultaneously with the bursting of the balloon, the payout ratio or the payout amount, etc. appears from within it, and a payout corresponding to that is paid out. Note that the above-described bonus game content is an example and the invention is not limited to that.

In the case that in S109 a bonus game has not been announced, CPU 51, based on the pay table stored in main memory 52, determines the payout to be paid to the player (S111) and causes the payout amount to be displayed in the “WON” column of main display 20 (S112). Note that, as examples of what is paid to the player as a slot game prize or a bonus game prize, the following may be cited: physical prizes, such as tokens, etc., or monetary prizes, such as coins, etc.

By announcing the bonus game prior to spinning of the reels in the above manner, the player can know ahead of time that a bonus game will run after the reels stop spinning. Thus, the player can readily confirm the start of the bonus game. Moreover, even if a bonus game has been announced, the transition to the bonus game cannot be made unless the symbols end up in a special arrangement. Thus, the player can be made to have a strong hope that the symbols do come to the special arrangement and, as a result, the amusement level is heightened and player interest is attracted to the game.

It can also be made such that, if in S103 there has been an announcement of a bonus game, there will be a transition to a bonus game (S110) whether or not there is a win in S108. In this way, it is made so that there is a possibility that a bonus game will be run regardless of the symbol arrangement. Thus, even if the player cannot win a prize due to the symbol arrangement, there is a chance to win a prize through a bonus game and there is even a chance to win prizes both through symbol arrangement and through a bonus game, so the player can be given a sense of freshness and his feeling of anticipation can be heightened.

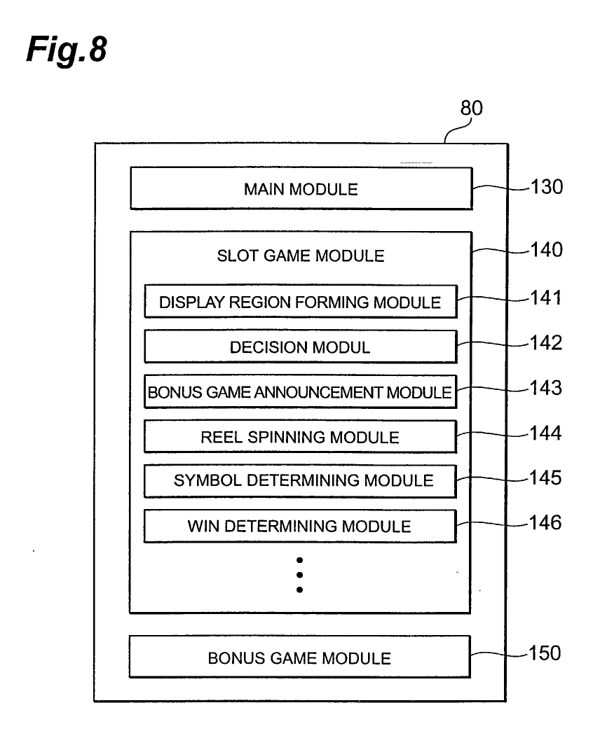

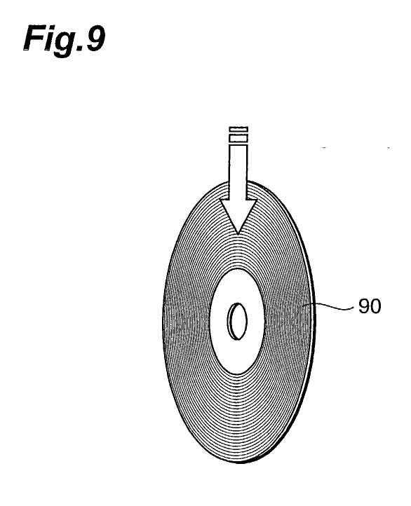

Next, preferred embodiments of a program according to the present invention and of a computer-readable recording medium in which the program is recorded are described with reference to FIG. 8 and FIG. 9.

FIG. 8 is a diagram showing each module in the program of the present embodiment; and FIG. 9 is a diagram showing CD-ROM (recording medium) 90 into which program 80 has been recorded.

Program 80 includes main module 130 which integrates the processing, slot game module 140 which relates to slot game processing, and bonus game module 150 which relates to bonus game processing.

Further, slot game module 140 includes at least: display region forming module 141, decision-making module 142, bonus game announcing module 143, reel spinning module 144, symbol determining module 145, and win determining module 146.

Display region forming module 141 is one which forms display regions on the display in which symbols are displayed. Decision-making module 142 is one which determines whether or not to run a bonus game after the reels stop spinning. Bonus game announcing module 143 is one which, in the case that a bonus game is to be run after the reels stop spinning, announces that fact. Reel spinning module 144 is one which displays the spinning reels on the display. Symbol determining module 145 determines the symbols to be displayed in each display region, based on random number values. Win determining module 146 makes decisions as to winnings, based on the symbols displayed in each display region.

Through the computer's execution of each of these modules, the processing of each of S101 through S112 of FIG. 6 can be accomplished in above-mentioned slot machine 10.

By installing program 80 of the above type, received as a carrier wave via a communications network such as the Internet, or program 80 recorded in a recording medium such as CR-ROM 90, in any type of computer, such as a personal computer, a PDA (Personal Digital Assistant), etc., games similar to the above-mentioned slot machine 10 can be realized.

Note that it is acceptable to build into program 80 the image data for the symbols, characters, etc. necessary for actualizing the game; the pay table; the correspondence table relating the bonus content in the bonus game and; etc. Alternatively, these data, etc. may be installed in the computer from a source other than the program. Further, all the various modules necessary for the processing performed by slot machine 10, not only the modules shown in FIG. 8, may be built into in program 80.

In addition, the above-mentioned recording device can be any kind of device as long as the information written into it can be read out by a computer. For example, this corresponds to magnetic disks such as floppy disks, optical disks such as DVD's, semiconductor storage devices, etc.

Above, the invention made by the present inventors was described concretely based on an embodiment, but the present invention is not limited to the abovementioned embodiment. For example, it can be made that the symbols in each display region rotate independently in the up-down direction without displaying spin-type reels. In addition, variation of the symbols displayed in the display regions on the display may be done by spinning mechanical-type reels on the circumference of which symbols are depicted.

In addition, selection of symbols for display in the display regions may be performed based on random number values obtained through a random number generator, without utilizing random numbers obtained from the program.

Further, the controller may be made into separate units for main display use and for second display use respectively, or game CPU's may be provided for displaying games on each display. In addition, the main display and second display may be any type of device, such as CRT plasma type, organic EL, etc.

In addition, instead of a bonus game, a specified payout may be made to the player or a bonus may be given such as the slot game going into a mode with higher chances of winning.

In addition, the gaming apparatus according to the present invention is not limited to the above-described slot machine. For example, the above-mentioned slot game may be implemented on the liquid crystal screen of a pachinko game, or it could be a game apparatus of the type provided with stop buttons whereby the player can stop the reels (for example, the game type known as “Pachi-suro,” short for Pachi[nko]-suro[to] [=“slot”]).

As described above, with the present invention, by providing a new method of running bonus games, it is possible to attract player interest and to enable a player readily to confirm that a bonus game has begun.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is

1. A gaming apparatus comprising:
a display having a plurality of symbol display regions in which a plurality of types of symbols are varyingly displayed; and
a controller for executing a prescribed program and controlling a display content of said display; and wherein
said controller, according to said program:
determines whether or not to run a bonus game after varying of said symbols stops;
in the event that a decision is made to run said bonus game, announces the bonus game prior to starting the varying of said symbols;
causes said symbols to be varyingly displayed on said display;
determines said symbol to be stopped in each of said display regions from among a plurality of types of said symbols;
decides a prize to be awarded to the player based on an arrangement of said symbols displayed in said display regions; and
in the event that the announcement of said bonus game has been made, runs the bonus game after said symbols have stopped.

2. The gaming apparatus according to claim 1, wherein said controller announces said bonus game only when there are credits.

3. The gaming apparatus according to claim 1, wherein said controller announces said bonus game whether or not there are credits.

4. The gaming apparatus according to claim 1, wherein said controller runs said bonus game only when said symbols come into a specified arrangement.

5. The gaming apparatus according to claim 1, wherein said controller determines whether or not to run said bonus game for the present game after detecting that the varying of said symbols has stopped in the previous game.

6. A slot machine which is equipped with a display having a plurality of symbol display regions in which a plurality of types of symbols are varyingly displayed, and which causes said symbols to be varyingly displayed on said display, determines said symbol to be stopped in each of said display regions from among a plurality of types of said symbols, and decides a prize to be awarded to the player based on an arrangement of said symbols displayed in said display regions; wherein
said slot machine comprises:
determining means for determining whether or not to run a bonus game after varying of said symbols stops;
announcing means for announcing said bonus game prior to starting the varying of said symbols, in the event that a decision has been made to run said bonus game; and
running means for running said bonus game after said symbols have stopped, in the event that said bonus game announcement has been made.

7. A control method for a gaming apparatus comprising a display, having a plurality of symbol display regions in which a plurality of types of symbols are varyingly displayed, and a controller for controlling a display content of said display; said control method comprising the steps of:
determining whether or not to run a bonus game after varying of said symbols has stopped;
announcing the bonus game prior to starting the varying of said symbols, in the event that a decision is made to run said bonus game;
causing said symbols to be varyingly displayed on said display;
determining said symbol to be stopped in each of said display regions from among a plurality of types of said symbols;
deciding a prize to be awarded to the player based on an arrangement of said symbols displayed in said display regions; and
running a bonus game after said symbols have stopped, in the event that the announcement of said bonus game has been made.

8. The gaming apparatus control method of claim 7, wherein said controller announces said bonus game only when there are credits;

9. The gaming apparatus control method according to claim 7, wherein said controller runs said-bonus game only when said symbols come into in a specified arrangement;

10. The gaming apparatus control method of claim 7, wherein said controller determines whether or not to run said bonus game for the present game, after detecting that varying of said symbols has stopped in the previous game.

11. A program which causes a computer to execute the steps of:
determining whether or not to run a bonus game after varying of said symbols has stopped;
announcing the bonus game prior to starting the varying of said symbols, in the event that a decision is made to run said bonus game;
causing said symbols to be varyingly displayed on said display;
determining said symbol to be stopped in each of said display regions from among a plurality of types of said symbols;
deciding a prize to be awarded to the player based on an arrangement of said symbols displayed in said display regions; and
running a bonus game after said symbols have stopped, in the event that the announcement of said bonus game has been made.

12. A computer-readable recording medium characterized in that the program of claim 11 is stored therein.
